(19) United States
(12) Patent Application Publication
(10) Pub. No.: US 2015/0350361 A1
(43) Pub. Date: Dec. 3, 2015

(54) PARALLEL PROCESSING ARCHITECTURE FOR LICENSE METRICS SOFTWARE

(71) Applicant: International Business Machines Corporation, Armonk, NY (US)

(72) Inventors: Umit Bektas, Krakow (PL); Pawel Januszek, Krakow (PL); Piotr Kania, Krakow (PL); Konrad K. Skibski, Krakow (PL)

(73) Assignee: International Business Machines Corporation, Armonk, NY (US)

(21) Appl. No.: 14/293,360

(22) Filed: Jun. 2, 2014

(51) Int. Cl. H04L 29/08; G06F 17/30

(52) U.S. Cl. CPC H04L 67/2833; H04L 67/10; G06F 17/30404

(57) ABSTRACT

In one embodiment, in accordance with the present invention, a method for parallel collection of software license metrics comprises receiving, by one or more processors at a host computer, a software asset management request; interpreting, by one or more processors at the host computer, the software asset management request to generate queries; transmitting, by one or more processors at the host computer, the generated queries to designated network endpoints; receiving, by one or more processors at the host computer, partial results transmitted to the host computer by processing units which form a subset of the network endpoints; and merging, by one or more processors at the host computer, the partial results to form a final response to the received software asset management request.

### FIELD OF THE INVENTION

The present invention relates generally to software asset management, and more particularly to a software asset management methodology having a parallel architecture.

### BACKGROUND OF THE INVENTION

Software Asset Management (SAM) is the practice used by organizations to reduce IT costs and maximize return on investments by optimizing purchasing, deploying, and maintaining software applications. There are several technologies and tools which can be used to implement and support the SAM process such as software inventory tools, license managers, application control tools, software deployment tools, request management tools, and patch management tools.

Software inventory tools are used to discover installed software over an organization's computer networks. These tools allow administrators to determine what software is installed on computers and servers and also provide information such as product IDs, program size, date installed, location on the hard disk, and installed version. Software license managers provide organizations with the ability to control what software applications are permitted to execute in their environments and where they can execute. Software license managers protect organizations from losses due to software piracy and also enable them to comply with software license agreements. Software license manager tools provide a repository of current license entitlements which can be cross-referenced with information from software inventory tools to provide a view of an organization's software licensing compliance. Application control tools restrict what software can be installed and executed on computers within an organization. Applications installed from unofficial sources are more likely to contain malicious code aimed at disrupting operations or stealing confidential information. Other benefits of application control include restricting the use of non-business applications to improve network performance or comply with HR guidelines, and managing endpoint configurations to enhance security.

Software deployment tools automate the deployment activities of new software. These activities include releasing new software, managing the installation and activation process, deactivating or removing selected software, updating, and retiring software applications. Request management tools allow organizations to manage and track software applications by requiring employees to place requests for applications. Patch management tools automate software application patches, which ensure all computers are using the latest and most secure software.

Software asset management solutions capacities are hard to scale, sometimes resulting in applications that do not meet current requirements for medium, large enterprise, or cloud environments. Software asset management discovery is based on defined scan groups, and schedules scans of the hardware and software topology. Agents perform scans only within a given period of time, which limit discovery to a single scan result within the given period. In this manner, real time discovery is not possible. If agents were configured to scan on a daily basis in a large scale environment, then the number of executable files and instances of each would result in massive volumes of data generated and would overload the SAM server.

### SUMMARY

Embodiments of the present invention disclose a method, computer program product, and system for parallel collection of software license metrics. In one embodiment, in accordance with the present invention, the method comprises receiving, by one or more processors at a host computer, a software asset management request; interpreting, by one or more processors at the host computer, the software asset management request to generate queries; transmitting, by one or more processors at the host computer, the generated queries to designated network endpoints; receiving, by one or more processors at the host computer, partial results transmitted to the host computer by processing units which form a subset of the network endpoints; and merging, by one or more processors at the host computer, the partial results to form a final response to the received software asset management request.

### BRIEF DESCRIPTION OF THE SEVERAL VIEWS OF THE DRAWINGS

FIG. 1 is a functional block diagram illustrating a software asset management environment, in an embodiment in accordance with the present invention.

FIG. 2 is a flowchart illustrating operational steps of a software asset management query on a host computer within the software asset management environment of FIG. 1.

FIG. 3 is a functional block diagram of a computer system in an embodiment in accordance with the present invention.

### DETAILED DESCRIPTION

### (1) Glossary

Software License Metrics—Measurable or detectable attributes of a software product or operating environment. License metrics can include, for example program name and version, as well as date and time of installation, and date and time of last update. License metrics can also include attributes of a computing device on which the software is installed, such as, for example, operating system, processor type, and number of processor cores.

Structured Query Language (SQL)—A programming language used primarily for manipulation of data elements stored in a data structure. Although often associated with databases, through appropriate application design, SQL can be used to support operations on remotely acquired data stored in a simpler data structure, for example.

Queries—SQL queries that result from interpreting software asset management requests. These queries are executed on processing units where calculations are performed, then the outputs of the calculations are transmitted to the host.

Verification Procedures—Rules used to gather data from agents. From time to time, updates may be generated by a system administrator that affect precisely how data should be gathered and how calculations should be performed in relation to specific installed software for which information is being collected. Upon receiving a user request, the host determines data to be collected and calculations to be performed and determines what rules to use from a repository on the host. These verification procedures are transmitted to the agents and processing units to use in their data collection and calculations.

Hash Function—An algorithm that is useful for mapping one set of data to another in an efficient manner. Although hash functions are often used in an effort to optimize searches for particular data elements, hash functions may also be utilized, as here, to achieve load balancing between a relatively large set of data-gathering agents and a smaller set of processing units tasked with assembling gathered data and performing calculations to achieve partial results.

Network Endpoints—Computing devices that may host software for which metrics are being collected. Network endpoints may include computing devices that merely act as agents, as well as the subset of agents that are designated as processing units.

Agent—The term agent is generally synonymous with network endpoint. In some instances in which usage can be inferred from context, the term agent may be used to distinguish computing devices merely hosting target software from the subset of computing devices that act as processing units.

Processing Units—A subset of network endpoints generally selected at initial system configuration, but subject to subsequent change by a system administrator. Processing units generally represent a group of network endpoints having at least a minimum amount of processing power, remaining online at all times using high availability features to maintain data from the whole environment, process queries, and return partial results to the host.

Scanning—Executing a utility program that resides on a network endpoint to collect data related to particular target software for which data is being collected. Scanning with the utility program generally utilizes updated verification procedures transmitted to the network endpoint by the host.

Partial Results—Results determined at a processing unit after collection of data from a subordinate group of agents. After all appropriate data has been collected at a processing unit and any required calculations have been completed, partial results are transmitted to the host.

Merging Partial Results—After partial results have been collected from all of the processing units, the host performs additional calculations to merge the partial results into a final result for transmission to a user.

### (2) Description of Embodiments

A desired aspect of Software Asset Management (SAM) tools is to discover software and hardware in real time. This is particularly applicable in environments with many agent computers and servers such as in medium to large enterprise and cloud environments. For example, in calculating the Processor Value Unit (PVU)/Resource Value Unit (RVU) license consumption, a desired result in the data aggregation process is reduced time and resource consumption. Implementing architecture similar to Massive Parallel Processing (MPP) in license metric software yields such results.

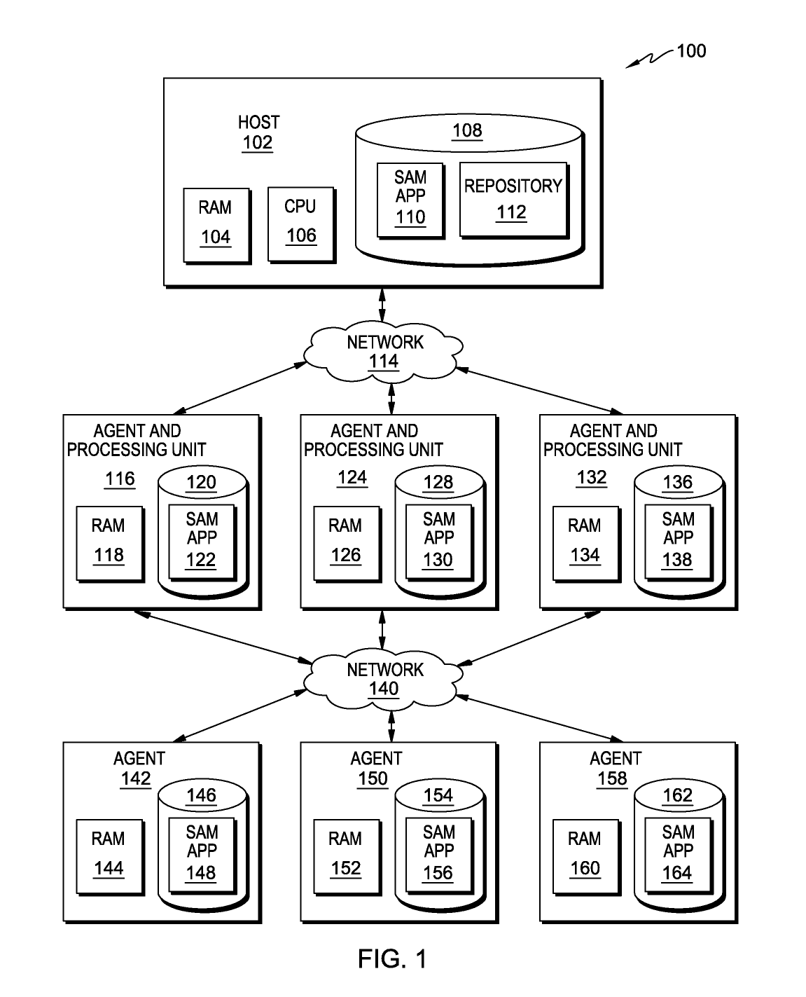

Embodiments in accordance with the present invention will now be described in detail with reference to the Figures. FIG. 1 is a functional block diagram illustrating a software asset management environment 100, in an embodiment in accordance with the present invention. A host computer or server 102 includes RAM 104, a central processing unit 106, and persistent storage 108. Persistent storage 108 may, for example, be a hard disk drive. Software asset management application 110 that is stored in persistent storage 108 includes operating system software as well as software that enables the host 102 to communicate with, and gather data from processing units (116, 124, and 132) and agents (142, 150, and 158) over a data connection. Software asset management application 110 coordinates user requests, determines data to be gathered, and calculations to be executed. It also is used to select a subset of network endpoints to be used as processing units 116, 124, and 132. Software asset management application 110 also determines rules to be used and then validates the determined rules in repository 112. It then coordinates the query execution and returns the final result. Persistent storage 108 also contains repository 112, used to store and validate verification steps. Repository 112 contains the most recent rules used to gather data from agents 142, 150, and 158. Upon receiving a user query, host 102 first determines data to be collected and calculations to be performed. Host 102 then determines what rules to use in repository 112. The rules are validated, then sent to agents 142, 150, and 158 and processing units 116, 124, and 132 to apply and begin processing.

Software asset management application 110 also interprets the user request into SQL queries and executes them on processing units 116, 124, and 132. Partial results are then sent back to host 102 where the final merge of data is preformed.

In FIG. 1, network 114 is shown as the interconnecting fabric between host 102, processing units 116, 124, and 132. In practice, the connection may be any viable data transport network, such as, for example, a LAN or WAN.

Processing units 116, 124, and 132, a subset of agents 142, 150, and 158, also contain RAM 118, 126, and 134 and persistent storage 120, 128, and 136 respectively, such as a hard disk drive. Software asset management application 122, 130, and 138 that is stored in persistent storage 120, 128, and 136 include operating system software as well as software that enables processing units 116, 124, and 132 to communicate with host 102, and gather data from agents 142, 150, and 158 to make the final calculation over a data connection. Processing units 116, 124, and 132 also receive the validated rules for the given query request and calculate their results, in addition to the results from agents 142, 150, and 158. Data is distributed to and among processing units 116, 124, and 132 using a globally defined hash function installed with SAM application 122, 130, 138, 148, 156, and 164. The globally defined hash function is generated by SAM application 110 on host computer 102, when processing units 116, 124, and 132 are defined, and is stored on all network endpoints. SQL queries are then performed on all data received from agents 142, 150, and 158, then data are returned to host 102 for the final merge, and results are delivered to the user. Processing units 116, 124, and 132 are expected to remain online at all times using high availability features to maintain data from the whole environment, process queries and return results to host 102. There can be many more processing units in this environment than are depicted in FIG. 1.

Network 140 is shown as the interconnecting fabric between processing units 116, 124, and 132 and agents 142, 150, and 158. In practice, the connection may be any viable data transport network, such as, for example, a LAN or WAN. The network could also be part of, or a subnet of network 114.

The agent computers or servers 142, 150 and 158 also have RAM 144, 152, and 160, and persistent storage 146, 154, and 162 respectively, such as a hard disk drive. Software asset management application 148 that is stored on persistent storage 146 includes operating software as well as applications and software that enable agents 142, 150 and 158 to communicate over a data connection. Agents 142, 150 and 158 are the source of data returned to the host 102. Software asset management application 148 performs checking actions, such as looking for particular software instances or discovering hardware infrastructure and monitoring processes in use. Verified rules are received and applied from host 102. Software application management software 148, 156, and 164 then performs the appropriate scan for the given software or hardware. Results are sent to processing units 116, 124, and 132 using a globally defined hash function that is defined and stored on agents 142, 150, and 158 at SAM installation time or when processing units are redefined. This environment can consist of many more agents than are depicted in this figure.

Software asset management application 110 that resides in persistent storage 108 is responsible for creating and retrieving verification steps that are sent to the agents 142, 150, and 158 for data collection. Software asset management application 110 also translates a user request into queries which are executed on processing units 116, 124, and 132. Partial results are then sent back to host 102 where software application 110 merges the final result. Repository 112, also residing on persistent storage 108, is used to store verification steps.

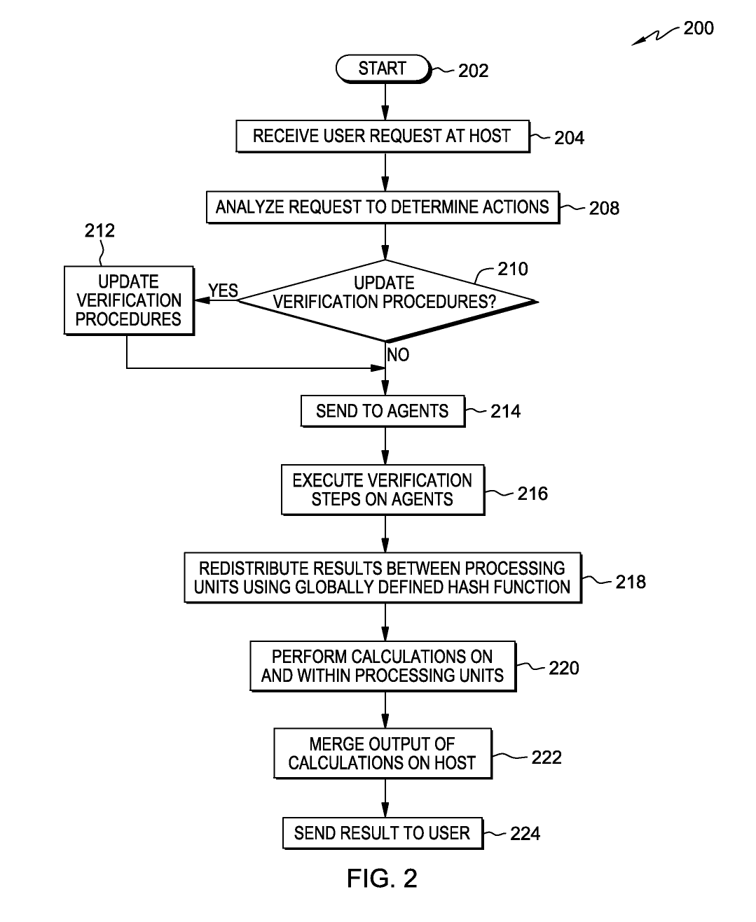

FIG. 2 is a flowchart, generally depicted by the numeral 200, illustrating operational steps of a software asset management query on a host computer 102 within the software asset management environment of FIG. 1. After a START state 202, a user request is received on the host (step 204). The host 102 analyzes the request to determine actions that need to be taken on processing units 116, 124, and 132 and agents 142, 150, and 158 to obtain all data to provide the result (step 208). In the next step 210, host 102 checks the repository 112 to determine if new verification steps are available for the action, or actions, stored in the verification procedure repository 112. In the event that new verification procedures are required, the host 102 will update the verification procedures as seen in step 212.

In step 214, the request to perform a check is sent to all agents in the environment. Agents 142, 150, and 158 as well as processing units 116, 124, and 132, receive the request from the host 102 and execute the verification steps (step 216). In step 218, results are redistributed among processing units 116, 124, and 132 using a globally defined hash function. Host 102 then interprets the software asset management request to SQL queries and executes them on processing units 116, 124, and 132. Calculations are then performed on and within processing units 116, 124, and 132 (step 220). The outputs of the calculations are then merged on the host 102 as seen in step 222. The result is then sent to the user (step 224).

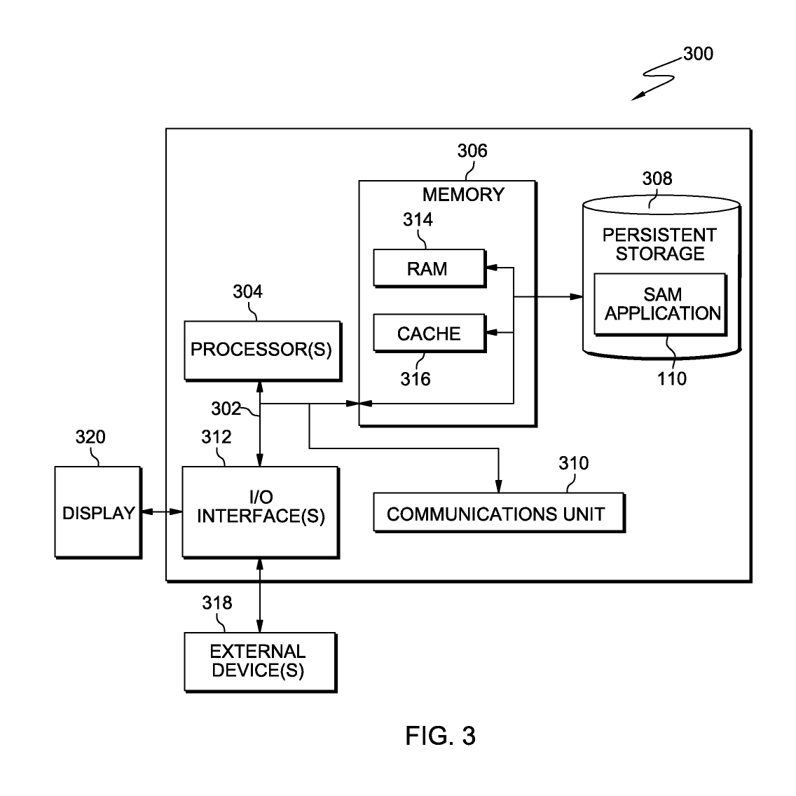

FIG. 3 is a functional block diagram of a computer system 300 in an embodiment in accordance with the present invention. Computer system 300 is representative of host computer 102 that hosts software asset management application 110, repository 112, data structures, or other resources in an illustrative embodiment in accordance with the present invention. It should be appreciated that FIG. 3 provides only an illustration of one implementation and does not imply any limitations with regard to the environments in which different embodiments may be implemented. Many modifications to the depicted environment may be made.

Computer system 300 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM) 314 and cache memory 316. In general, memory 306 can include any suitable volatile or non-volatile computer readable storage media.

Software asset management program 110 and repository 112 (not shown on FIG. 3) are stored in persistent storage 308 for execution and/or access by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of networks 114 and 140, as well as processing units 116, 124, and 132 and agents 142, 150, and 158 as shown in FIG. 1. In these examples, communications unit 310 includes one or more network interface cards. Communications unit 310 may provide communications through the use of either or both physical and wireless communications links. Software asset management program 110 and repository 112 may be downloaded to persistent storage 308 through communications unit 310.

I/O interface(s) 312 allows for input and output of data with other devices that may be connected to computer system 300. For example, I/O interface 312 may provide a connection to external devices 318 such as a keyboard, keypad, a touch screen, and/or some other suitable input device. External devices 318 can also include portable computer readable storage media such as, for example, thumb drives, portable optical or magnetic disks, and memory cards. Software and data used to practice embodiments in accordance with the present invention, e.g., software asset management program 110 and repository 112, can be stored on such portable computer readable storage media and can be loaded onto persistent storage 308 via I/O interface(s) 312. I/O interface(s) 312 also connect to a display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for parallel collection of software license metrics, the method comprising:
receiving, by a designated network endpoint, a software asset management request, wherein the software asset management request is also received by a plurality of non-designated network endpoints;
identifying, by the designated network endpoint, first asset data that is relevant in responding to the software asset management request, wherein the first asset data pertains to the designated network endpoint and is stored on the designated network endpoint;
receiving, by the designated network endpoint, second asset data that is relevant in responding to the software asset management request, wherein the second asset data pertains to the plurality of non-designated network endpoints and is received from the plurality of non-designated network endpoints;
calculating, by the designated network endpoint, a result of the software asset management request from the identified first asset data and the received second asset data; and
sending, by the designated network endpoint, the calculated result to a host computer.

2-5. (canceled)

6. (canceled)

7-21. (canceled)

22. The method of claim 1, wherein the calculated result is sent to the host computer for merging with additional results sent by one or more additional designated endpoints.

23. The method of claim 1, wherein the first asset data and the second asset data are identified by their respective network endpoints according to a set of verification procedures, and wherein the result is calculated according to the set of verification procedures.

24. The method of claim 23, wherein the verification procedures are received from the host.

25. The method of claim 1, wherein the second asset data is received according to a globally defined hash function.

26. The method of claim 1, wherein the identification of the first asset data includes scanning the designated network endpoint to collect data related to particular target software.

27. The method of claim 1, wherein the second asset data relates to particular target software on the plurality of non-designated network endpoints.

28. A computer program product for parallel collection of software license metrics, the computer program product comprising:
one or more computer readable storage media and program instructions stored on the one or more computer readable storage media, the program instructions comprising:
program instructions to receive, by a designated network endpoint, a software asset management request, wherein the software asset management request is also received by a plurality of non-designated network endpoints;
program instructions to identify, by the designated network endpoint, first asset data that is relevant in responding to the software asset management request, wherein the first asset data pertains to the designated network endpoint and is stored on the designated network endpoint;
program instructions to receive, by the designated network endpoint, second asset data that is relevant in responding to the software asset management request, wherein the second asset data pertains to the plurality of non-designated network endpoints and is received from the plurality of non-designated network endpoints;
program instructions to calculate, by the designated network endpoint, a result of the software asset management request from the identified first asset data and the received second asset data; and
program instructions to send, by the designated network endpoint, the calculated result to a host computer.

29. The computer program product of claim 28, wherein the calculated result is sent to the host computer for merging with additional results sent by one or more additional designated endpoints.

30. The computer program product of claim 28, wherein the first asset data and the second asset data are identified by their respective network endpoints according to a set of verification procedures, and wherein the result is calculated according to the set of verification procedures.

31. The computer program product of claim 30, wherein the verification procedures are received from the host.

32. The computer program product of claim 28, wherein the second asset data is received according to a globally defined hash function.

33. The computer program product of claim 28, wherein the identification of the first asset data includes scanning the designated network endpoint to collect data related to particular target software.

34. The computer program product of claim 28, wherein the second asset data relates to particular target software on the plurality of non-designated network endpoints.

35. A computer system for parallel collection of software license metrics, the computer system comprising:
one or more computer processors;
one or more computer readable storage media;
program instructions stored on the computer readable storage media for execution by at least one of the one or more processors, the program instructions comprising:
program instructions to receive, by a designated network endpoint, a software asset management request, wherein the software asset management request is also received by a plurality of non-designated network endpoints;
program instructions to identify, by the designated network endpoint, first asset data that is relevant in responding to the software asset management request, wherein the first asset data pertains to the designated network endpoint and is stored on the designated network endpoint;
program instructions to receive, by the designated network endpoint, second asset data that is relevant in responding to the software asset management request, wherein the second asset data pertains to the plurality of non-designated network endpoints and is received from the plurality of non-designated network endpoints;
program instructions to calculate, by the designated network endpoint, a result of the software asset management request from the identified first asset data and the received second asset data; and
program instructions to send, by the designated network endpoint, the calculated result to a host computer.

36. The computer system of claim 35, wherein the calculated result is sent to the host computer for merging with additional results sent by one or more additional designated endpoints.

37. The computer system of claim 35, wherein the first asset data and the second asset data are identified by their respective network endpoints according to a set of verification procedures, and wherein the result is calculated according to the set of verification procedures.

38. The computer system of claim 37, wherein the verification procedures are received from the host.

39. The computer system of claim 35, wherein the second asset data is received according to a globally defined hash function.

40. The computer system of claim 35, wherein the identification of the first asset data includes scanning the designated network endpoint to collect data related to particular target software, and wherein the second asset data relates to particular target software on the plurality of non-designated network endpoints.
